(19) United States
(12) Patent Application Publication
(10) Pub. No.: US 2016/0283379 A1
(43) Pub. Date: Sep. 29, 2016

(54) CACHE FLUSHING UTILIZING LINKED LISTS

(71) Applicant: Avago Technologies General IP (Singapore) Pte. Ltd., Singapore (SG)

(72) Inventors: Sumanesh Samanta, Bangalore (IN); Horia Cristian Simionescu, Milpitas, CA (US); Ashish Jain, Bangalore (IN)

(21) Appl. No.: 14/671,012

(22) Filed: Mar. 27, 2015

(51) Int. Cl. G06F 12/08; G06F 12/12

(52) U.S. Cl. CPC G06F 12/0833; G06F 12/0848; G06F 12/128; G06F 2212/282; G06F 2212/69; G06F 2212/621

(57) ABSTRACT

Methods and structure for utilizing linked lists to flush a cache. One exemplary embodiment includes a memory, an interface, and an Input/Output (I/O) processor. The memory implements a cache divided into cache lines, and the interface receives I/O directed to a block address of a storage device. The I/O processor determines a remainder by dividing the block address by the number of cache lines, and selects a cache line for storing the I/O based on the remainder. The I/O processor determines a quotient by dividing the block address by the number of cache lines, and associates the quotient with the selected cache line. Additionally, the I/O processor populates a linked list by inserting entries that each point to a different cache line associated with the same quotient, and flushes the cache lines to the storage device in block address order by traversing the entries of the linked list.

### FIELD OF THE INVENTION

The invention relates generally to data storage, and more specifically to caching.

### BACKGROUND

In a storage system, a host transmits requests to a storage controller in order to store or retrieve data. The host requests can indicate that data should be written to, or read from, one or more Logical Block Addresses (LBAs) of a logical volume. The storage controller processes incoming host requests to correlate the requested LBAs with physical addresses on one or more storage devices that store data for the volume. The storage controller can translate a host request into individual Input/Output (I/O) operations that are each directed to a storage device for the logical volume, in order to retrieve or store data at the correlated physical addresses. Storage controllers are just one example of the many electronic devices that utilize caches in order to enhance their overall speed of processing.

### SUMMARY

Systems and methods herein provide for enhanced cache flushing techniques that use linked lists to determine which lines of dirty (unsynchronized) cache data should be flushed from a write cache to a storage device, in order to synchronize the storage device with the cache. In one embodiment, a linked list can be ordered in a manner that ensures lines of the cache are flushed to a storage device in ascending or descending order of block address. This provides a substantial decrease in latency when a large number of cache lines are flushed to a storage device comprising a spinning hard disk.

One exemplary embodiment is a system that includes a memory, an interface, and an Input/Output (I/O) processor. The memory implements a cache divided into multiple cache lines, and the interface is able to receive I/O directed to a block address of a storage device. The I/O processor is able to determine a remainder by dividing the block address by the number of cache lines, and to select a cache line for storing the I/O based on the remainder. The I/O processor is further able to determine a quotient by dividing the block address by the number of cache lines, and to associate the quotient with the selected cache line. Additionally, the I/O processor is able to populate a linked list by inserting entries into the linked list that each point to a different cache line associated with the same quotient, and to flush the cache lines to the storage device in block address order by traversing the entries of the linked list.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary caching system.

FIG. 2 is a block diagram of an exemplary operating environment for a caching system.

FIG. 3 is a flowchart describing an exemplary method to operate a caching system.

FIG. 4 is a block diagram illustrating an exemplary cache and cache table.

FIGS. 5-6 are block diagrams illustrating an exemplary array for indexing a linked list, and multiple exemplary linked lists.

FIG. 7 is a flow chart describing an exemplary method for inserting entries into linked lists that direct flushing operations at a cache.

FIG. 8 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

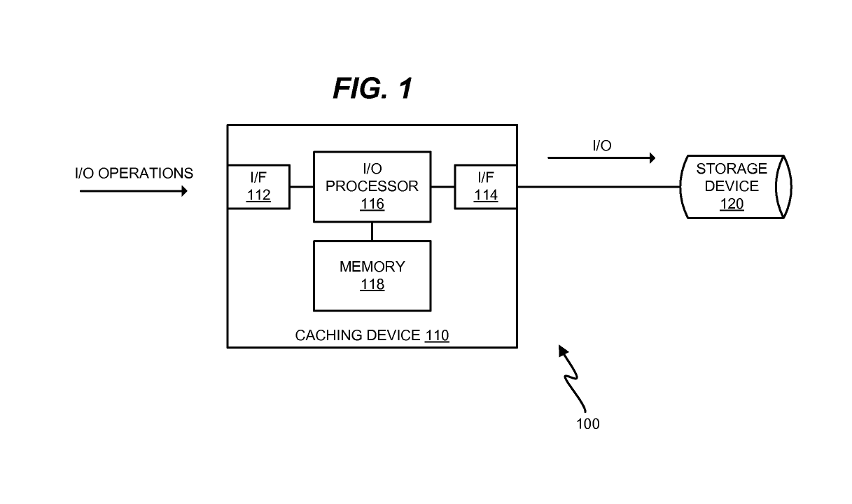

FIG. 1 is a block diagram of an exemplary caching system 100. Caching system 100 comprises any system, component, or device operable to cache data for later writing/flushing to one or more storage devices. Thus, caching system 100 operates as a “dirty write cache.” In this embodiment, caching system 100 operates in a write back mode to cache I/O received from a host system. The term “I/O,” when used by itself, refers to data for storing at (or retrieving from) a storage device. When the cache is operated in write back mode, incoming write requests from the host are stored in the cache and reported to the host as completed, and then are later flushed to storage device 120 by caching device 110.

Caching system 100 provides a benefit over prior systems, because it utilizes linked lists to direct the order of flushing operations at a cache. This provides two substantial benefits. First, a linked list can be used to flush cache lines of data to a storage device in either ascending or descending block address order, which ensures that the storage device can quickly write I/O from the cache, particularly when the storage device utilizes a spinning disk recording medium. Second, a linked list can use substantially less memory overhead (e.g., Double Data Rate (DDR) Random Access Memory (RAM) overhead) than an Adelson-Velsky and Landis (AVL) tree, a Red-Black (RB) tree, or similar binary tree structures. For example, a tree structure may require three four byte pointers per entry, while the linked lists described herein may use one per entry. In embodiments where a cache is divided into millions of cache lines, this reduced overhead can provide substantial space savings for the memory implementing the cache (e.g., DDR RAM).

According to FIG. 1, caching system 100 comprises caching device 110 and storage device 120. While shown as physically distinct entities in FIG. 1, in further embodiments caching device 110 is integrated into storage device 120 (e.g., as a Solid State Drive (SSD) cache for a hybrid hard disk). Caching device 110 stores I/O for incoming host requests before that I/O is flushed to storage device 120 (e.g., for persistent storage). In this embodiment, caching device 110 comprises interface (I/F) 112 which is operable to receive host requests. Caching device 110 further comprises I/O processor 116 and memory 118, as well as I/F 114 for transmitting cached I/O to storage device 120. I/O processor 116 comprises any suitable components and/or devices for managing the caching operations performed at caching device 110. I/O processor 116 manages a cache stored at memory 118, and operates I/Fs 112 and 114 in order to transmit and receive data for caching at storage device 120.

I/O processor 116 can be implemented as custom circuitry, a processor executing programmed instructions stored in program memory, or some combination thereof. Memory 118 comprises a storage medium for retaining data to be flushed to storage device 120. Memory 118 can benefit from properties such as increased bandwidth and reduced latency. For example, in one embodiment memory 118 comprises a solid-state flash memory, while in another embodiment memory 118 comprises a Non-Volatile Random Access Memory (NVRAM) that is backed up by an internal battery. Implementing memory 118 as a non-volatile storage medium provides enhanced data integrity.

In this embodiment, storage device 120 implements the persistent storage capacity of storage system 100 and is capable of storing data in a computer readable format. For example, storage device 120 can comprise a magnetic hard disk, a solid state drive, an optical medium, etc. The various components of FIG. 1, including the interfaces described above, can be compliant with protocols for Small Computer System Interface (SCSI), Serial Attached SCSI (SAS), Serial Advanced Technology Attachment (SATA), Peripheral Component Interconnect Express (PCIE), Fibre Channel, etc.

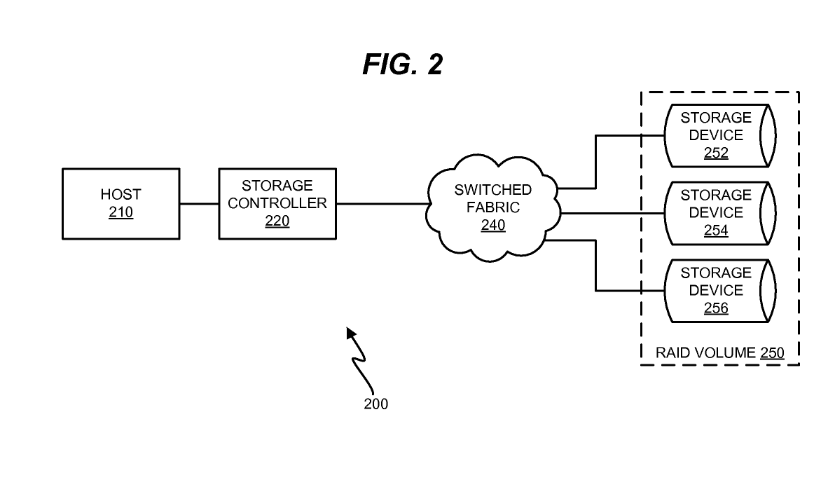

FIG. 2 is a block diagram of an exemplary operating environment 200 for a caching system. In this embodiment, a storage controller 220 operates as a caching device for a logical Redundant Array of Independent Disks (RAID) volume 250 implemented on storage devices 252, 254, and 256. Switched fabric 240 comprises any combination of communication channels operable to forward/route communications, for example, according to protocols for one or more of SCSI, SAS, Fibre Channel, Ethernet, Internet SCSI (ISCSI), etc. In one embodiment, switched fabric 240 comprises a combination of SAS expanders that link a SAS initiator to one or more SAS/SATA targets.

Storage devices 252, 254, and 256 implement storage space for the logical RAID volume 250. As discussed herein, a logical volume comprises allocated storage space and data available at operating environment 200. A logical volume can be implemented on any number of storage devices as a matter of design choice. Furthermore, the storage devices need not be dedicated to only one logical volume, but can also store data for a number of other logical volumes. Implementing a logical volume as a RAID volume enhances the performance and/or reliability of stored data.

The particular arrangement, number, and configuration of components described herein is exemplary and non-limiting. Additional caching systems and techniques are described in detail at U.S. patent application Ser. No. 14/337,409, titled “SELECTIVE MIRRORING IN CACHES FOR LOGICAL VOLUMES,” filed on Jul. 22, 2014, which is herein incorporated by reference.

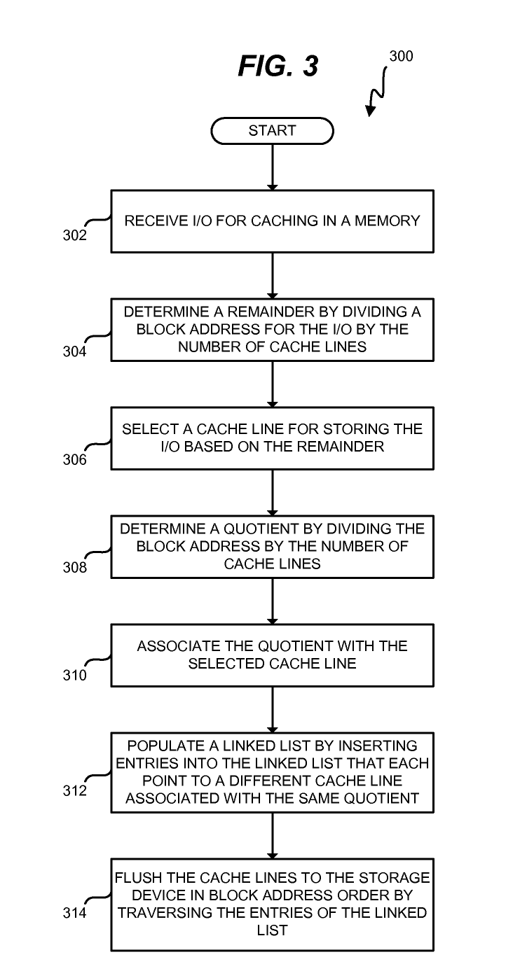

Further details of the operation of caching device 110 are described in detail with regard to FIG. 3 below. Assume, for this embodiment, that the cache implemented by memory 118 is divided into multiple cache lines, where each cache line is capable of caching data for a block address range (e.g., a range of block addresses totaling 64 KB in size) at storage device 120. Further, assume that it is desirable to flush data from the cache lines to storage device 120 in block address order (i.e., ascending or descending order with respect to physical block addresses at storage device 120). For example, if storage device 120 is a magnetic hard disk, flushing data in block address order reduces the overall write time when a large group of cache lines are flushed.

FIG. 3 is a flowchart describing an exemplary method 300 for operating caching device 110. In step 302, interface 112 receives I/O for caching in memory 118. The I/O can be defined for example by a write request from a host system or other device. The I/O (or the request that defines the I/O) can specifically indicate the block address on storage device 120 that the I/O is directed to, or can refer to a Logical Block Address (LBA) for a logical volume implemented on storage device 120, in which case I/O processor 116 translates the LBA into a block address on storage device 120. If the I/O encompasses a range of block addresses, I/O processor 116 selects the start address (or end address) of the I/O to use as the block address for the I/O. Further, if the I/O encompasses multiple cache lines of data, the start address described above can be used for a first cache line of I/O, while further cache lines for the I/O can add an offset to the start address described above (e.g., an offset corresponding to a single cache line, such as 64 KB) in order to determine their own start address.

In step 304, I/O processor 116 determines a remainder number, by dividing the block address by the number of cache lines in the cache at memory 118. For example, a modulo operation can be performed to determine the remainder. This remainder is used to determine which cache line will store the data for the block address.

In step 306, I/O processor 116 selects a cache line in memory 118 for storing the I/O, based on the remainder determined in step 304. In this embodiment, the cache lines are numbered in the cache in sequence, and step 306 comprises selecting a corresponding cache line with the number that equals the remainder. This means that each of the cache lines is reserved for storing a set of block addresses that have a common remainder when divided by the number of cache lines. In one embodiment, if the corresponding cache line is dirty and already occupied with data waiting to be flushed to storage device 120, then I/O processor 116 reviews a threshold number of cache lines that follow the cache line, and inserts the I/O into the first empty cache line that it finds. For example, I/O processor 116 can review the fifteen cache lines that follow the corresponding cache line, and select the first empty cache line that is found.

After a cache line has been selected, I/O processor 116 stores the I/O at the selected cache line. When the I/O is large enough to occupy multiple cache lines, this can further comprise storing the I/O at the selected cache line as well as cache lines that immediately follow the selected cache line.

In step 308, I/O processor 116 determines a quotient by dividing the block address by the number of cache lines. The quotient is the integer result of the division. Step 308 does not necessarily require dividing the block address by the number of cache lines again, and may be determined when division is first performed in step 304. In step 310, I/O processor 116 associates the quotient with the selected cache line. In one embodiment, this comprises storing the quotient in a table/array that tracks the status of each cache line.

Steps 302-310 repeat each time new I/O is received for caching in memory 118. In this manner, the cache lines of memory 118 fill up with data for flushing to storage device 120. Steps 312-314 illustrate how a linked list can be used to flush data from the cache lines to storage device 120. Therefore, steps 312-314 can be performed substantially simultaneously and asynchronously with steps 302-310. Steps 312-314 utilize one or more linked lists that each correspond with a different quotient. That is, in steps 312-314, each linked list includes a set of entries that each correspond with a single cache line, and all of the entries of a linked list point to cache lines associated with the same quotient. The entries of each linked list are sorted in remainder order, meaning that the entries of each linked list are also sorted in block address order. When the linked lists are constructed in this manner, I/O processor 116 can quickly flush I/O in block address order by traversing the linked lists in quotient order.

In step 312, I/O processor 116 populates a linked list by inserting entries into the linked list that each point to a different cache line associated with the same quotient. In this embodiment, as described above, there are multiple linked lists (e.g., stored in memory 118) that each correspond with a different quotient. The linked lists can be populated by reviewing each cache line in the cache. For example, in one embodiment, I/O processor 116 reviews the dirty cache lines in sequence. For each cache line, I/O processor 116 determines the quotient for the cache line, and adds an entry for the cache line to the tail of the linked list corresponding to that quotient. I/O processor 116 can further link the tail entry of a linked list for a quotient to the head entry of a linked list for a next quotient. In this manner the linked lists form a continuous chain of entries in block address order for flushing data to storage device 120. This results from the cache lines storing I/O in remainder order, while being distributed across the linked lists in quotient order. In short, for a given linked list, the entries each point to a different cache line but are associated with the same quotient.

In step 314, I/O processor 116 flushes the cache lines to storage device 120 in block address order, by traversing the entries of the linked list. In embodiments where there is a linked list for each quotient, this result can be achieved by traversing the multiple linked lists in quotient order (e.g., ascending or descending). Flushing the cache lines in the order defined by the linked lists ensures that writes are applied to storage device 120 in block address order, which provides a performance benefit for storage devices that utilize spinning disks (such as magnetic hard disks).

Even though the steps of method 300 are described with reference to caching system 100 of FIG. 1, method 300 can be performed in other systems and devices that utilize a cache memory. The steps of the flowcharts described herein are not all inclusive and can include other steps not shown. The steps described herein can also be performed in an alternative order.

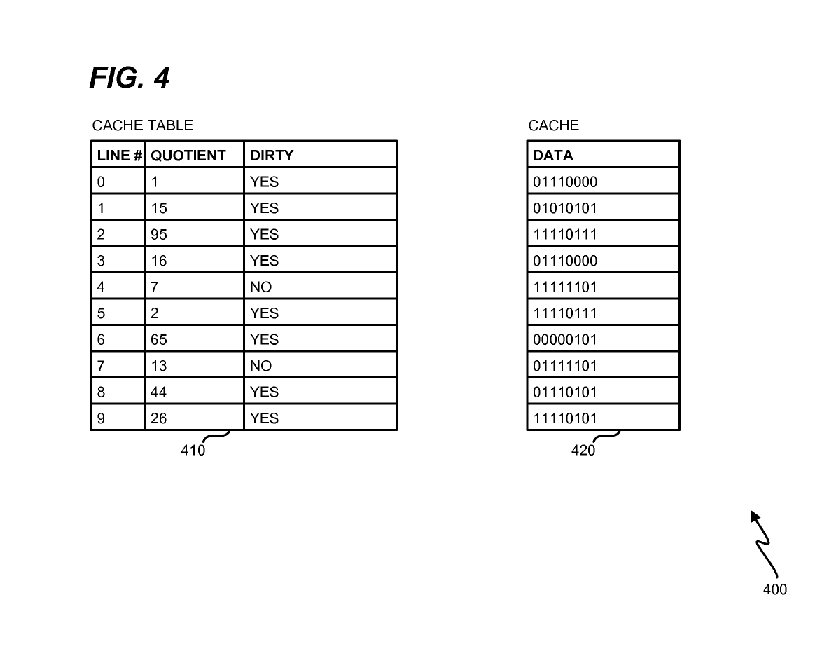

FIG. 4 is a block diagram 400 illustrating an exemplary cache 420 and cache table 410. In this embodiment, cache 420 is divided into multiple cache lines, and each cache line stores I/O for writing to a block address of a storage device. Meanwhile, cache table 410 includes a multi-field entry for each cache line. One field indicates the quotient for a cache line, while another field indicates whether the cache line is dirty. Since only dirty cache lines should be flushed to storage device 120, an I/O processor can review a single Boolean field at cache table 410 to determine whether or not a cache line should be flushed in the first place. Then, an I/O processor can review the quotient for the given cache line if the cache line is dirty, and quickly decide which linked list to add an entry to, based on the quotient.

### EXAMPLES

In the following examples, additional processes, systems, and methods are described in the context of a cache for a SAS storage controller. In this example, the storage controller receives host write requests that are directed to LBAs of a logical volume, and translates the write requests into SAS I/O operations directed to specific block addresses of individual storage devices. The storage controller utilizes a cache to store I/O for the write requests, and operates the cache in a write back mode to report successful completion of write requests to the host before those write requests are flushed to persistent storage. The cache itself comprises sixteen million cache lines, and each cache line is capable of storing a 64 Kilobyte (KB) block of data. The logical volume that the cache stores data for is a one terabyte logical volume. In this example, multiple caches are kept on a cache memory device, one for each logical volume. However, further discussion of this example is limited to the single cache for the single volume described above. Similar operations to those described in this example can be performed for each of the caches on the storage controller.

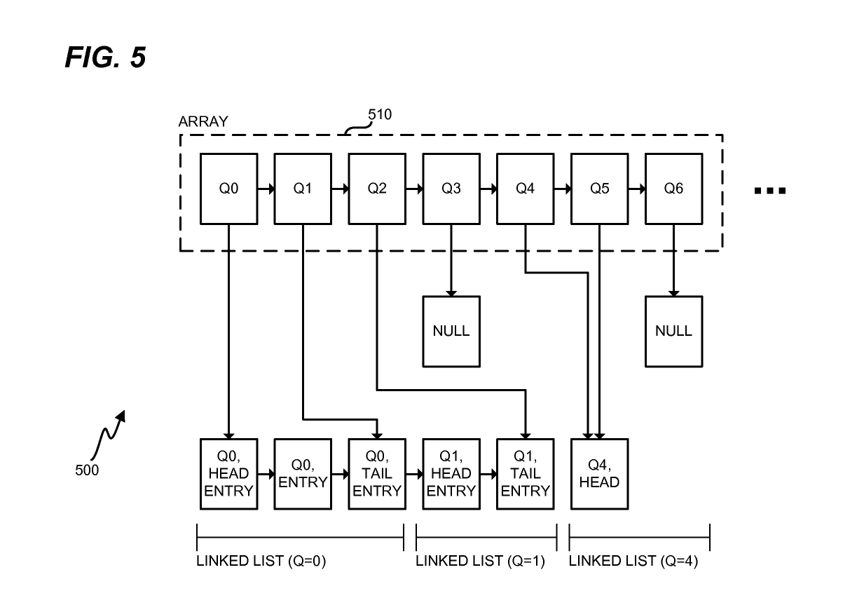

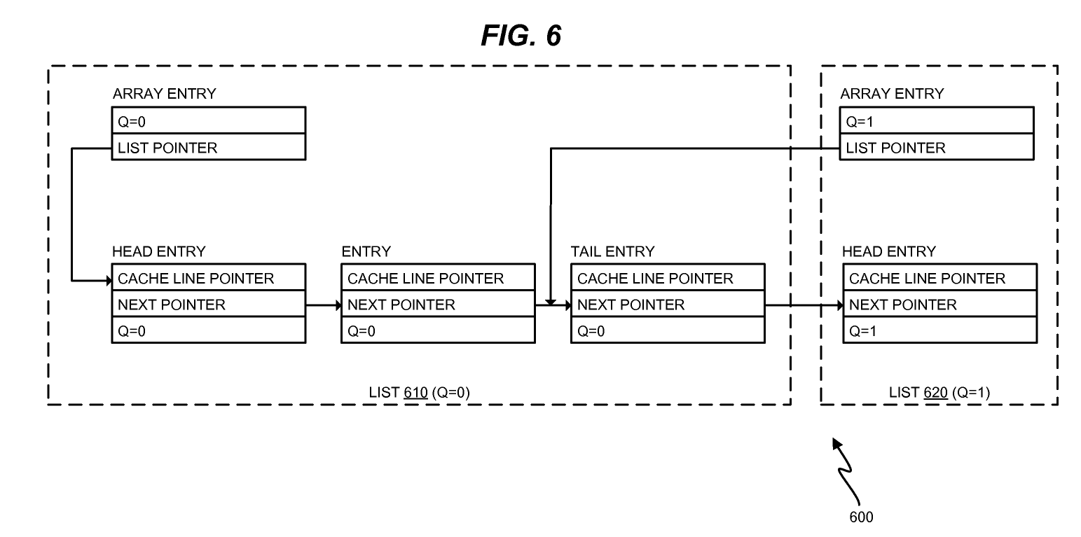

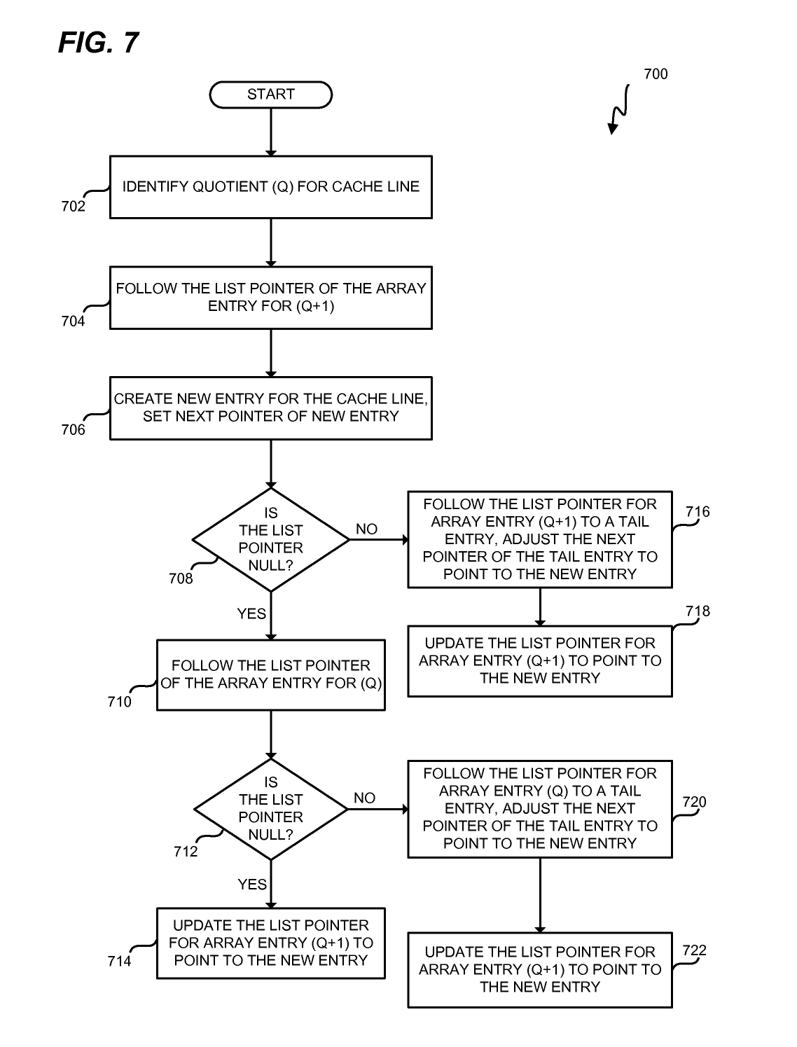

FIGS. 5-6 are block diagrams 500-600 illustrating an exemplary array for indexing a linked list, and multiple exemplary linked lists. In this example as shown in FIG. 5, the storage controller utilizes an array/table 510 to store a series of “list pointers” that are each associated with a linked list for a different quotient. Whenever an I/O processor of the storage controller attempts to visit a linked list for a given quotient, the I/O processor follows a corresponding list pointer in array 510. Each list pointer in array 510 either points to an entry in a linked list, or is null. In this embodiment, the list pointer for the quotient of three (Q3) is null, as is the list pointer for Q6. Meanwhile, the list pointer for Q0 points to the head entry in the linked list for Q0, the list pointer for Q1 points to the tail entry for the linked list for Q0, the list pointer for Q2 points to the tail entry for the linked list for Q1, and the list pointers for Q4 and Q5 both point to the head entry (which is also the tail entry) for the linked list for Q4. The reason why some of the list pointers point to head entries, while other list pointers point to tail entries, will be described in detail below with regard to FIG. 7. In short, this structure allows for the use of one-way linked lists (wherein each linked list entry has only a next pointer) instead of two-way linked lists (wherein each linked list entry has both a next pointer and a previous pointer), which reduces the overhead of the linked lists as stored in memory.

In this embodiment, each entry in a linked list includes the quotient that the entry is associated with, a pointer to a cache line, and a next pointer directed to a next entry in the linked list. When flushing cache lines to storage device 120, an I/O processor starts with the list pointer for Q0. If the list pointer is null, the I/O processor reviews the next list pointer (for Q1). Alternatively, if the list pointer for Q0 is not null, the I/O processor follows the list pointer to an entry in a linked list. The I/O processor flushes the cache line that the linked list entry points to, marks the cache line as “clean” (instead of dirty) and follows the next pointer of the linked list entry to visit the next entry of the linked list. The linked list entry for the flushed cache line is also removed. The I/O processor continues in this manner flushing cache lines and following next pointers. Since the next pointer for a tail entry of a linked list points to the head entry of the linked list for a next quotient, the I/O processor continues flushing cache entries (for potentially multiple quotients) until it finds a linked list entry with a null next pointer. At that point in time, the I/O processor determines the quotient of the current entry, and follows the list pointer for the next quotient in order to find the next linked list (or set of linked lists). Once the linked lists have been traversed and the cache lines flushed, their entries have been removed by I/O processor 116. The linked lists can therefore now be repopulated based on the current composition of the cache lines.

FIG. 6 further illustrates the contents of the array and exemplary linked lists of FIG. 5. FIG. 6 illustrates the contents of linked list 610 (for Q0), as well as linked list 620 (for Q1). In this example, the linked lists are one-way linked lists, which substantially reduces pointer overhead when compared to two-way linked lists. The array entry for each linked list is included in the box indicated by the dashed lines for that linked list. Although at first it appears counterintuitive to point a list pointer for a quotient to the tail entry of the linked list for the prior quotient, it allows for a one-way linked list to be quickly and efficiently populated using method 700 described below.

FIG. 7 is a flow chart describing an exemplary method 700 for inserting entries into linked lists that direct flushing operations at a cache. According to FIG. 7, when analyzing a cache line, in step 702 an I/O processor identifies a quotient (Q) for the cache line (e.g., by consulting a cache table or a specific field for the cache line). In step 704, the I/O processor follows the list pointer in the array entry for Q+1. This is because the list pointer in the array entry for Q+1 will generally point to the tail entry of the linked list for Q.

Next, in step 706 the I/O processor creates a new entry for the cache line, and sets the next pointer of the new entry. If the linked list for Q+1 is empty and has no entries (e.g., as indicated by the list pointer in the array entry for (Q+2)), then the next pointer for the new entry is set to null. Otherwise, the next pointer for the new entry is set to the head entry of the linked list for Q+1.

Next, if the list pointer in the array entry is not null in step 708, then a linked list exists for Q. Thus, in step 716, the I/O processor follows the list pointer in the array entry for Q+1, which points to the tail entry of the linked list for Q. The I/O processor then changes the next pointer of the tail entry to point to the new entry. This makes the new entry the tail entry for linked list Q. In step 718, the I/O processor updates the list pointer for the array entry for Q+1 to point to the newly created entry.

If the pointer in the array entry is currently null in step 708, then there is no linked list for Q, meaning that the cache line is the first detected cache line that is associated with Q. Thus, the I/O processor follows the list pointer for the array entry for Q in step 710, and determines whether the list pointer is null in step 712. If the list pointer for Q is null, then the previous linked list (the linked list for Q−1) is also empty and has no entries. Thus, in step 714, the I/O processor updates the list pointer for the array entry for Q+1 to point to the new entry.

If in step 712 the list pointer for the array entry for Q is not null, then a linked list already exists for the previous linked list (the linked list for Q−1). Thus, in step 720, the I/O processor follows the list pointer for the array entry for Q to a tail entry for the previous linked list, and adjusts the next pointer of that tail entry to point to the new entry. This effectively links the tail entry of the linked list for Q−1 to the new entry, which operates as the head for the linked list for Q. At step 722, the I/O processor further updates the list pointer for the array entry for Q+1 to point to the new entry.

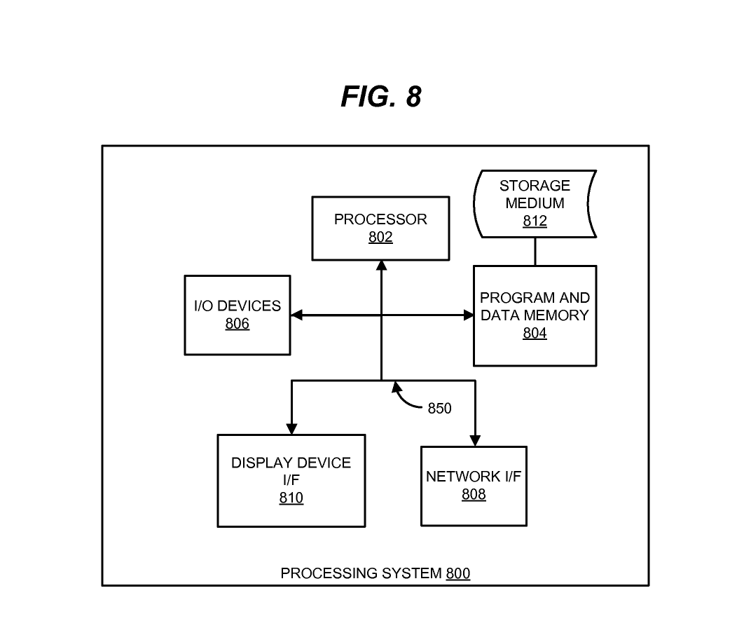

Embodiments disclosed herein can take the form of software, hardware, firmware, or various combinations thereof. In one particular embodiment, software is used to direct a processing system of a caching device to perform the various operations disclosed herein. FIG. 8 illustrates an exemplary processing system 800 operable to execute a computer readable medium embodying programmed instructions. Processing system 800 is operable to perform the above operations by executing programmed instructions tangibly embodied on computer readable storage medium 812. In this regard, embodiments of the invention can take the form of a computer program accessible via computer readable medium 812 providing program code for use by a computer (e.g., processing system 800) or any other instruction execution system. For the purposes of this description, computer readable storage medium 812 can be anything that can contain or store the program for use by the computer (e.g., processing system 800).

Computer readable storage medium 812 can be an electronic, magnetic, optical, electromagnetic, infrared, or semiconductor device. Examples of computer readable storage medium 812 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 800, being used for storing and/or executing the program code, includes at least one processor 802 coupled to program and data memory 804 through a system bus 850. Program and data memory 804 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 806 (including but not limited to keyboards, displays, pointing devices, etc.) can be coupled either directly or through intervening I/O controllers. Network adapter interfaces 808 can also be integrated with the system to enable processing system 800 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 810 can be integrated with the system to interface to one or more display devices, such as printing systems and screens for presentation of data generated by processor 802.

1. A system comprising:
a memory implementing a cache divided into multiple cache lines;
an interface operable to receive Input/Output (I/O) directed to a block address of a storage device; and
an I/O processor operable to determine a remainder by dividing the block address by the number of cache lines, and to select a cache line for storing the I/O based on the remainder,
the I/O processor further operable to determine a quotient by dividing the block address by the number of cache lines, and to associate the quotient with the selected cache line,
the I/O processor further operable to populate a linked list by inserting entries into the linked list that each point to a different cache line associated with the same quotient, and to flush the cache lines to the storage device in block address order by traversing the entries of the linked list.

2. The system of claim 1, wherein:
the I/O processor is further operable to populate multiple linked lists by:
for each of the multiple linked lists, inserting entries that are associated with the same quotient, wherein entries inserted into different linked lists are associated with different quotients.

3. The system of claim 2, wherein:
one of the linked lists includes a tail entry that points to a head entry of another linked list, and
the I/O processor is further operable to follow entries from the one linked list to the other linked list.

4. The system of claim 2, wherein:
each of the cache lines is associated with a different remainder,
the I/O processor is further operable to populate the multiple linked lists by:
analyzing the cache lines in order based on their associated remainders; and
for each cache line:
identifying the quotient associated with the cache line; and
adding an entry for the cache line to the tail of a linked list associated with the identified quotient.

5. The system of claim 1, wherein:
each of the cache lines is associated with a different remainder, and
the cache lines are sorted in the cache in order based on the remainder of each cache line.

6. A method comprising:
receiving Input/Output (I/O) for caching at a memory implementing a cache divided into multiple cache lines, wherein the I/O is directed to a block address of a storage device;
determining a remainder by dividing the block address by the number of cache lines;
selecting a cache line for storing the I/O based on the remainder;
determining a quotient by dividing the block address by the number of cache lines;
associating the quotient with the selected cache line;
populating a linked list by inserting entries into the linked list that each point to a different cache line associated with the same quotient; and
flushing the cache lines to the storage device in block address order by traversing the entries of the linked list.

7. The method of claim 6, further comprising:
populating multiple linked lists by:
for each of the multiple linked lists, inserting entries that are associated with the same quotient, wherein entries inserted into different linked lists are associated with different quotients.

8. The method of claim 7, wherein:
one of the linked lists includes a tail entry that points to a head entry of another linked list, and
the method further comprises following entries from the one linked list to the other linked list.

9. The method of claim 7, wherein:
each of the cache lines is associated with a different remainder, wherein the method further comprises:
populating the multiple linked lists by:
analyzing the cache lines in order based on their associated remainders; and
for each cache line:
identifying the quotient associated with the cache line; and
adding an entry for the cache line to the tail of a linked list associated with the identified quotient.

10. The method of claim 6, wherein:
each of the cache lines is associated with a different remainder, and
the cache lines are sorted in the cache in order based on the remainder of each cache line.

11. A non-transitory computer readable medium embodying programmed instructions which, when executed by a processor, are operable for directing the processor to:
receive Input/Output (I/O) for caching at a memory implementing a cache divided into multiple cache lines, wherein the I/O is directed to a block address of a storage device;
determine a remainder by dividing the block address by the number of cache lines;
select a cache line for storing the I/O based on the remainder;
determine a quotient by dividing the block address by the number of cache lines;
associate the quotient with the selected cache line;
populate a linked list by inserting entries into the linked list that each point to a different cache line associated with the same quotient; and
flush the cache lines to the storage device in block address order by traversing the entries of the linked list.

12. The medium of claim 11, wherein the instructions further direct the processor to:
populate multiple linked lists by:
for each of the multiple linked lists, inserting entries that are associated with the same quotient, wherein entries inserted into different linked lists are associated with different quotients.

13. The medium of claim 12, wherein:
one of the linked lists includes a tail entry that points to a head entry of another linked list, and
the instructions further direct the processor to follow entries from the one linked list to the other linked list.

14. The medium of claim 12, wherein:
each of the cache lines is associated with a different remainder, and the instructions further direct the processor to:
populate the multiple linked lists by:
analyzing the cache lines in order based on their associated remainders; and
for each cache line:
identifying the quotient associated with the cache line; and
adding an entry for the cache line to the tail of a linked list associated with the identified quotient.

15. The medium of claim 11, wherein:
each of the cache lines is associated with a different remainder, and
the cache lines are sorted in the cache in order based on the remainder of each cache line.

16. A system comprising:
a memory implementing a cache divided into multiple cache lines that are each reserved for storing data for a different set of block addresses at a storage device, wherein each cache line is reserved for storing a set of block addresses that have a common remainder when divided by the number of cache lines;
an interface operable to receive Input/Output (I/O) directed to a block address of a storage device; and
an I/O processor operable to select a cache line for storing the I/O based on the set of block addresses reserved for the cache line,
the I/O processor further operable to determine a quotient by dividing the block address by the number of cache lines, and to associate the quotient with the selected cache line,
the I/O processor further operable to generate a linked list with entries that each point to a different cache line but are associated with the same quotient, and to flush the cache lines to the storage device in order of address, by traversing the entries of the linked list.

17. The system of claim 16, wherein:
the I/O processor is further operable to populate multiple linked lists by:
for each of the multiple linked lists, inserting entries that are associated with the same quotient, wherein entries inserted into different linked lists are associated with different quotients.

18. The system of claim 17, wherein:
one of the linked lists includes a tail entry that points to a head entry of another linked list, and
the I/O processor is further operable to follow entries from the one linked list to the other linked list.

19. The system of claim 17, wherein:
the I/O processor is further operable to populate the multiple linked lists by sequentially parsing the cache lines, and for each cache line: identifying the quotient associated with the cache line, and adding an entry for the cache line to the tail of a linked list associated with the identified quotient.

20. The system of claim 16, wherein:
each of the cache lines is associated with a different remainder, and
the cache lines are sorted in the cache in order based on the remainder of each cache line.

21. A method for managing a cache divided into multiple cache lines, the method comprising:
reserving each of the cache lines for storing data for a different set of block addresses at a storage device, wherein each cache line is reserved for storing a set of block addresses that have a common remainder when divided by the number of cache lines;
receiving Input/Output (I/O) directed to a block address of a storage device;
selecting a cache line for storing the I/O based on the set of block addresses reserved for the cache line;
determining a quotient by dividing the block address by the number of cache lines;
associating the quotient with the selected cache line;
generating a linked list with entries that each point to a different cache line but are associated with the same quotient; and
flushing the cache lines to the storage device in order of address, by traversing the entries of the linked list.

22. The method of claim 21, further comprising:
populating multiple linked lists by:
for each of the multiple linked lists, inserting entries that are associated with the same quotient, wherein entries inserted into different linked lists are associated with different quotients.

23. The method of claim 22, wherein:
one of the linked lists includes a tail entry that points to a head entry of another linked list, and
the method further comprises following entries from the one linked list to the other linked list.

24. The method of claim 22, further comprising:
populating the multiple linked lists by sequentially parsing the cache lines, and for each cache line:
identifying the quotient associated with the cache line; and
adding an entry for the cache line to the tail of a linked list associated with the identified quotient.

25. The method of claim 21, wherein:
each of the cache lines is associated with a different remainder, and
the cache lines are sorted in the cache in order based on the remainder of each cache line.
